(19) United States
(12) Patent Application Publication
(10) Pub. No.: US 2008/0259742 A1
(43) Pub. Date: Oct. 23, 2008

(54) METHODS AND SYSTEMS FOR CONTROLLING ALARM CLOCKS

(75) Inventor: Hagihara Tadanori, Miaoli Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/738,545

(22) Filed: Apr. 23, 2007

(51) Int. Cl. G04B 23/03

(52) U.S. Cl. 368/263

(57) ABSTRACT

Methods for controlling an alarm clock, employed in a mobile electronic device, are provided. An embodiment of a method for controlling an alarm clock comprises the mobile electronic device sounding when reaching a preset alarm time. The mobile electronic device stops sounding the alarm when detecting a first signal. It is determined whether at least one second signal is detected during a predetermined detection period subsequent to the detected prior signal. A delay duration is determined in response to number of times of the detected second signals. The alarm time is reset by increasing the calculated delay duration.

### BACKGROUND

The invention relates to alarm clocks, and more particularly, to methods and systems for modifying snooze settings.

A mobile electronic device may provide alarm clock function simulated by an application with a real-time clock (RTC) and relevant firmware. A speaker is directed to buzz or play a predetermined alarm melody or tone by the alarm clock application executed by a processor thereof when reaching a preset time. Subsequently, the speaker is directed to stop buzzing or playing the predetermined alarm melody or tone by the alarm clock application executed by a processor thereof when receiving a cancellation signal.

### SUMMARY

Methods for controlling an alarm clock, employed in a mobile electronic device, are provided. An embodiment of a method for controlling an alarm clock comprises the mobile electronic device sounding when reaching a preset alarm time. The mobile electronic device stops sounding the alarm when detecting a first signal. It is determined whether at least one second signal is detected during a predetermined detection period subsequent to the detected prior signal. A delay duration is determined in response to a number of times of the detected second signals. The alarm time is reset by increasing the calculated delay duration.

Systems for controlling an alarm clock, disposed on a mobile electronic device, are provided. An embodiment of a system for controlling an alarm clock comprises a speaker and a processor. The processor, coupled to the speaker, directs the speaker to sound when reaching an alarm time, directs the speaker to stop sounding when detecting a first signal, determines whether at least one second signal is detected during a predetermined detection period subsequent to the detected prior signal, determines a delay duration in response to a number of times of the detected second signals, and resets the alarm time by increasing the calculated delay duration.

### BRIEF DESCRIPTION OF DRAWINGS

The invention can be more fully understood by reading the subsequent detailed description and examples with references made to the accompanying drawings, wherein:

FIG. 1 is a diagram of a hardware environment applicable in a mobile electronic device;

FIGS. 2a, 2b and 2c are exemplary display menus for configuring alarm times;

FIGS. 3a, 3b and 3c are exemplary display menus for configuring snooze settings;

FIGS. 4a to 4d are schematic diagrams of embodiments of a motion sensor;

FIG. 5 is a flowchart illustrating an embodiment of a snooze control method;

FIGS. 6 and 7 are diagrams of appearance of embodiments of a mobile phone;

FIG. 8 is a flowchart illustrating an embodiment of a snooze control method.

### DETAILED DESCRIPTION

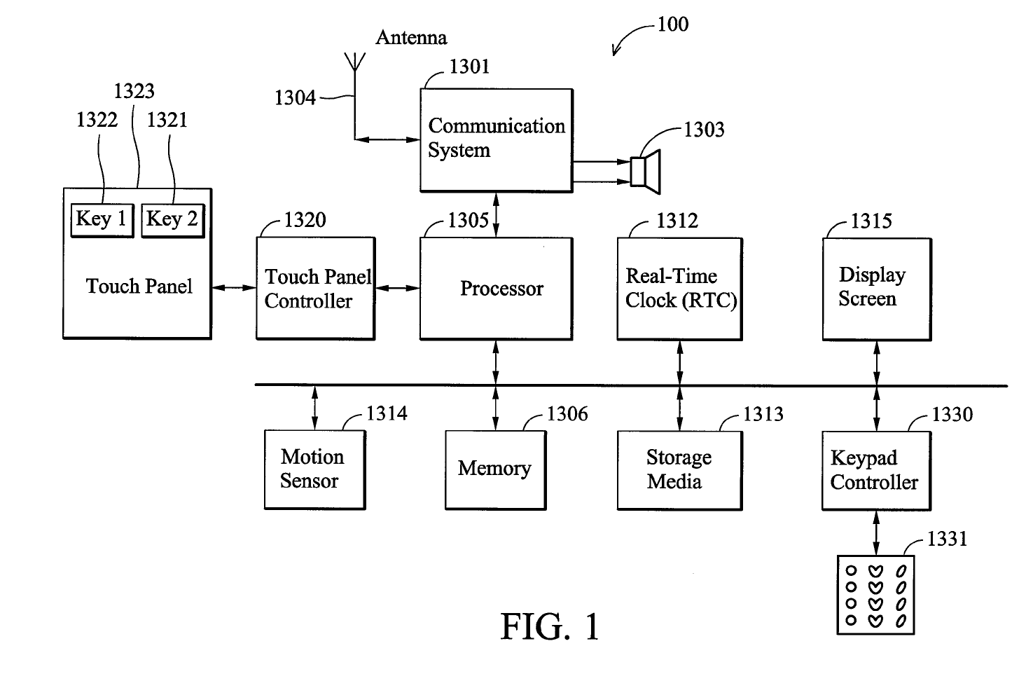

Methods for controlling alarm clocks employed in mobile electronic devices such as mobile phones, smart phones and the like, are provided. FIG. 1 is a diagram of a hardware environment applicable to a mobile electronic device 100 mainly comprising a communication system 1301, a speaker 1303, an antenna 1304, a processor 1305, memory 1306, a real-time clock (RTC) 1312, storage media 1313, a motion sensor 1314, a display screen 1315, a touch panel controller 1320 and a keypad controller 1330. The communication system 1301, such as global system for mobile communications (GSM), general packet radio service (GPRS), enhanced data rates for global evolution (EDGE), code division multiple access (CDMA), wideband code division multiple access (WCDMA) or circuit switched data (CSD) system or other, communicates with other remote mobile electronic devices via the antenna 1304 when connecting to a cellular network such as the GSM, GPRS, EDGE, CDMA, WCDMA, CSD network or other. The processor 1305 connects to the touch panel controller 1320, RTC 1312, motion sensor 1314, display screen 1315, memory 1306, storage media 1313 and keypad controller 1330 via various bus architectures.

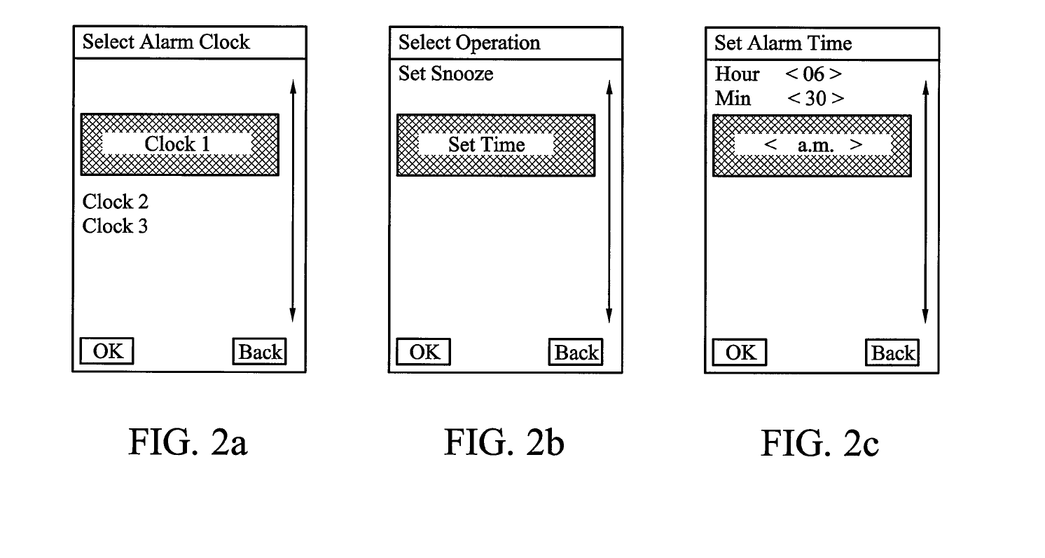

An alarm clock application may interact with an alarm clock configuration man-machine interface (MMI) to acquire alarm times configured by users and accordingly set the configured alarm times to the RTC 1312. The alarm clock configuration MMI may be a combination of menus displayed on the touch panel 1323 and/or the display screen 1313, and keystroke event handling routines (i.e. executable code executed when specific key keystroke signals are detected by the keypad controller 1330 or the touch panel controller 1302), defining interaction with the mobile electronic device 100. FIGS. 2a, 2b and 2c are exemplary display menus for configuring alarm times. FIG. 2a is a selection menu facilitating selection of a specific alarm clock to be configured. When a menu item “Clock 1” corresponding to the first alarm clock is selected, an operation selection menu as shown in FIG. 2b is displayed. When a menu item “Set Time” is selected, an alarm time configuration menu as shown in FIG. 2c is displayed. Alarm times can be set by hour, minute and am/pm for the first alarm clock. After completing configuration of alarm times by users via the alarm clock configuration MMI, the alarm clock application may store the alarm time in memory 1306 or storage media 1313 and issue clock setting commands to the RTC 1312 to set alarm times (e.g. 6:00, 17:00, 6:00 p.m., 9:00 a.m. and others) via relevant RTC firmware drivers. When detecting that one of the set alarm times is reached, the RTC may issue an alarm interrupt to trigger an alarm interrupt service routine (ISR), the alarm ISR may transmit an alarm message to notify the alarm clock application that one of the set alarm times has been reached, and consequently, the alarm clock application may direct the speaker 1313 to buzz, play a predetermined alarm tone or melody, or other, via digital signal processor (DSP, not shown) with relevant DSP firmware drivers. It is to be understood that the described alarm clock application, alarm ISR, RTC and RTC firmware driver can be executed by the processor 1305.

An alarm clock application may interact with the alarm clock MMI to acquire snooze settings for alarm clocks configured by users. Three snooze parameters for each alarm clock, such as termination means, snooze activation means and an extending duration, can be configured. Users may configure the termination means to control whether the alarm is terminated by a hard key stroke or by shaking. For example, the termination means can be configured to terminate the alarm by a hard key stroke. The speaker 1303 stops buzzing or playing a predetermined alarm tone or melody when the keypad controller 1330 detects that any hard key on the keypad 1331 has been pressed or the touch panel controller 1302 detects any soft key on the touch panel 1323 has been clicked. Note that the termination means may be configured to indicate that alarm is terminated by a particular key stroke such as a key stroke on “menu”, “*” or “#” key or other. In another example, the termination means is configured to terminate the alarm by shaking. A speaker stops buzzing, playing a predetermined alarm tone or melody when the motion sensor 1314 detects agitation. In addition, users may configure the snooze activation means to indicate whether alarm snooze is activated by a hard key stroke or by shaking, and the extending duration to one, two or three minutes or other. For example, the snooze activation means can be configured to activate the snooze by a hard key stroke and the snooze extending duration set to three minutes. The speaker 1303 stops buzzing or playing a predetermined alarm tone or melody when the keypad controller 1330 has detected that any hard key on the keypad 1331 has been pressed once or the touch panel controller 1302 has detected that any soft key on the touch panel 1323 has been clicked once. Thereafter, the speaker 1303 will buzz or play the predetermined alarm tone or melody again after three minutes elapses. Note that the snooze activation means may be configured to indicate that the snooze mechanism is activated by a particular key stroke such as a key stroke on “menu”, “*” or “#” key or other. In another example, the snooze activation means can be configured to activate the snooze by shaking and the snooze extending duration is set to two minutes. The speaker 1303 stops buzzing or playing a predetermined alarm tone or melody after the motion sensor 1314 detects one agitation. Thereafter, the speaker 1303 will buzz or play the predetermined alarm tone or melody again after two minutes elapses. The details of snooze operations based on the described snooze settings will be further described in the following paragraphs with relevant flowcharts.

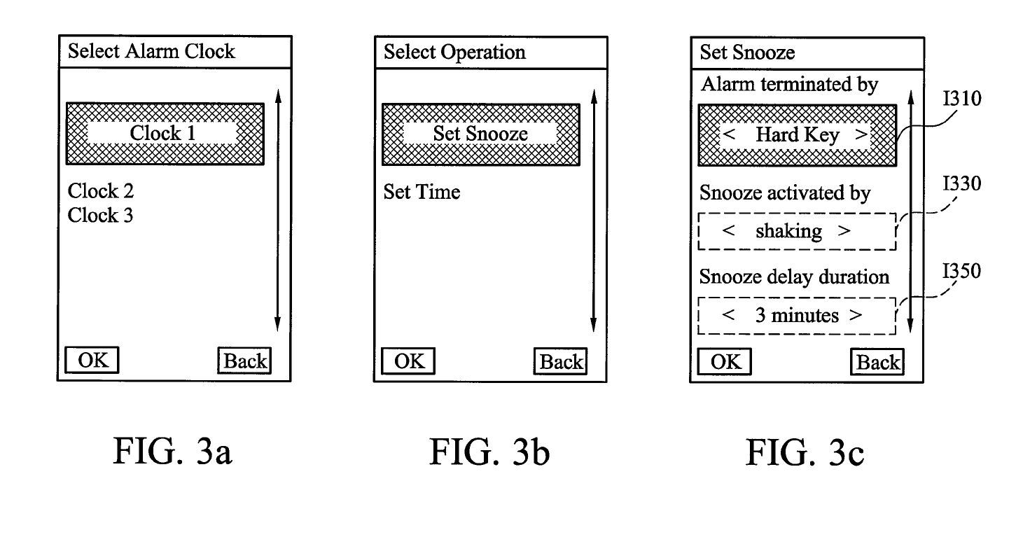

FIGS. 3a, 3b and 3c are exemplary display menus for configuring snooze settings. FIG. 3a is a selection menu facilitating selection of a specific alarm clock to be configured. When a menu item “Clock 1” corresponding to the first alarm clock is selected, an operation selection menu as shown in FIG. 3b is displayed. When a menu item “Set Snooze” is selected, a snooze configuration menu as shown in FIG. 2c is displayed. The snooze configuration menu provides three menu items 1310 to 1350 respectively facilitating configuration of termination means, snooze activation means, and extending duration for the first alarm clock. After completing configuration of snooze settings by users via the alarm clock configuration MMI, the alarm clock application may store the snooze settings in memory 1306 or storage media 1313.

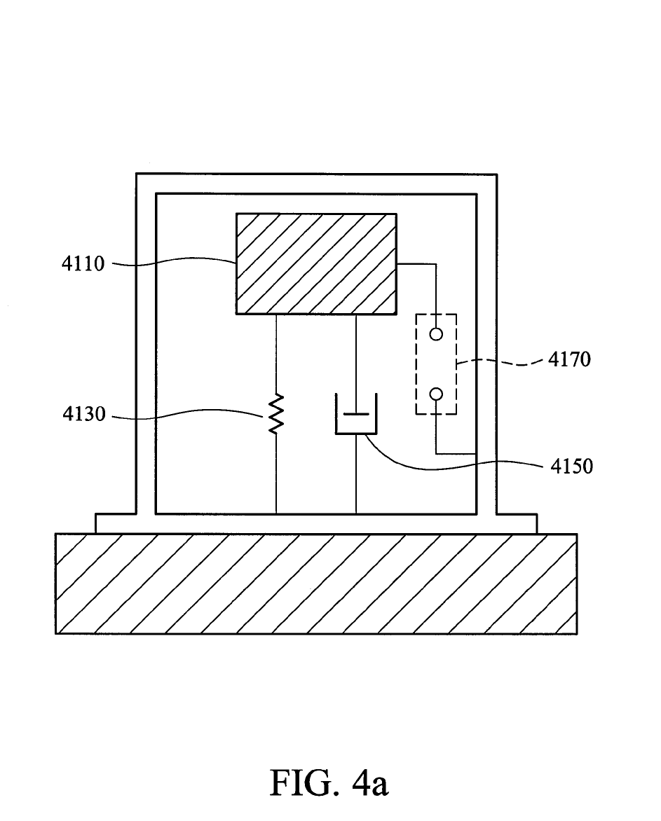

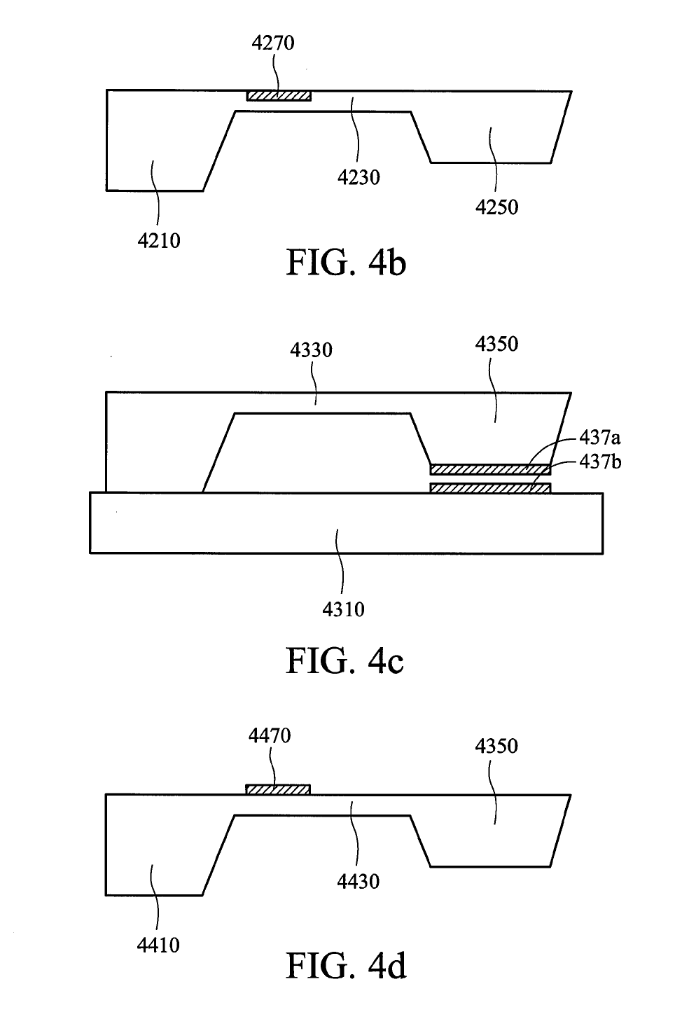

Referring to FIG. 2, the motion sensor 1314 detects agitation of mobile electronic device 100, preferably via an accelerometer. FIGS. 4a to 4d are schematic diagrams of embodiments of the motion sensor 1314. Referring to FIG. 4a, an embodiment of the motion sensor 1314 comprises an inertial object 4110, springs 4130, a damper 4150 and a conversion unit 4170. The inertial object 4110 is supported by springs 4130. Upon acceleration, a force causes the inertial object 4110 to deviate from a zero-acceleration position until the restoring force from springs 4130 balances the acceleration force. The magnitudes of the inertial-object deflection are converted into representative electrical signals, which appear at the sensor output, when the mobile electronic device 100 is shaken. Referring to FIG. 4b, an embodiment of the motion sensor 1314, a piezoresistive accelerometer, comprises a base 4210, a bridge 4230, an inertial object 4250 and a piezoresistor 4270. The inertial object 4250 is supported by the bridge 4230. Upon acceleration, a force causes the inertial object 4250 to enlongate or compress, resulting in variations in piezoresistance detected by piezoresistor 4270. The magnitude of the variations in piezoresistance is converted to representative electrical signals when the mobile electronic device 100 agitates. Referring to FIG. 4c, an embodiment of the motion sensor 1314, a capacitive accelerometer, comprises a base 4310, a bridge 4330, an inertial object 4350 and two electrodes 4370a and 4370b. The electrode 4370a is disposed on the surface of the inertial object 4350 and the electrode 4370b is disposed on the surface of the base 4310 to form a plane capacitor. Upon acceleration, a force creates a gap between the inertial object 4350 and base 4310, resulting in variations in capacitance. The magnitude of the variations in capacitance is converted to representative electrical signals when the mobile electronic device 100 agitates. Referring to FIG. 4d, an embodiment of the motion sensor 1314, a piezoelectric accelerometer, comprises a base 4410, a bridge 4430, an inertial object 4450 and piezoelectric material 4470. The inertial object 4450 is supported by the bridge 4430. Upon acceleration, a force causes the piezoelectric material 4470 to deform, resulting in piezoelectric effect of the piezoelectric material 4470. The magnitude of the piezoelectric effect of the piezoelectric material 4470 is converted to representative electrical signals when the mobile electronic device 100 agitates.

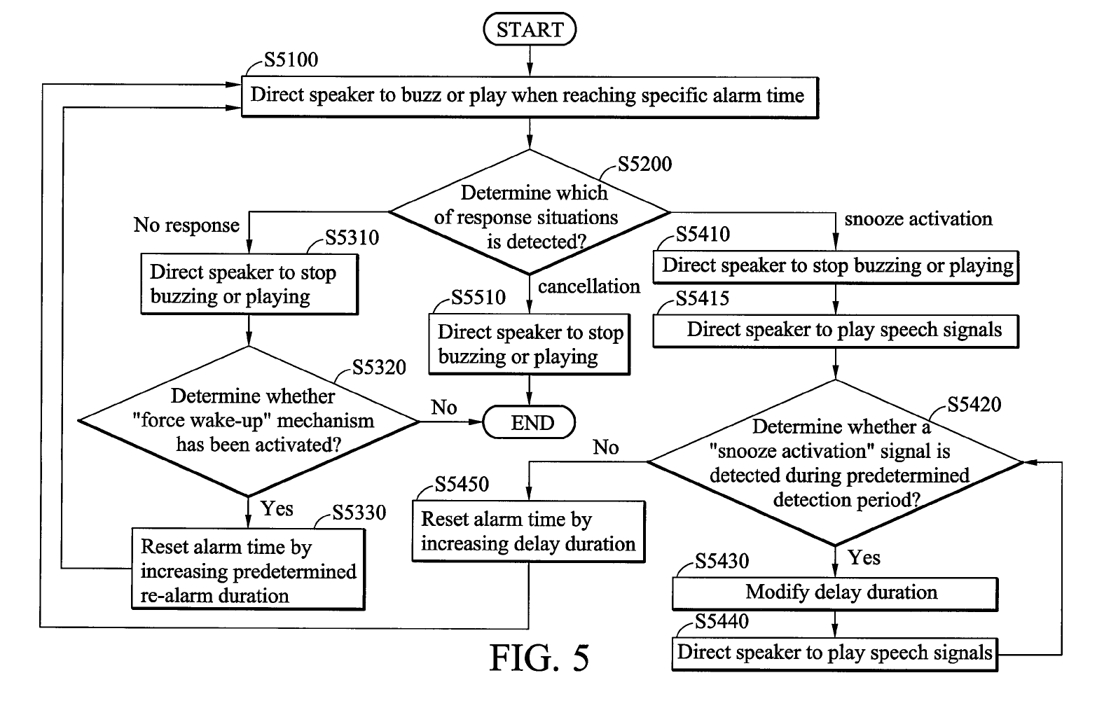

FIG. 5 is a flowchart illustrating an embodiment of a snooze control method, performed by a processor (e.g. 1305 or FIG. 1). In step S5100, a speaker (e.g. 1303 of FIG. 1) is directed to buzz or play a predetermined alarm melody or tone when reaching a specific alarm time. The alarm time may be configured via the described alarm clock MMI by a user. The processor detects that the specific alarm time is reached when an alarm message is received from the described ISR. In step S5200, it is determined which of response situations such as “no response”, “cancellation” and “snooze activation”, is detected. Specifically, when receiving no signal (or receiving none of “cancellation” and “snooze activation” signals) from a keypad controller (e.g. 1330 of FIG. 1) after a predetermined period of time such as ten or twenty minutes, a half hour or other, step S5200 determines to enter the “no response” mode and the process proceeds to step S5310. When receiving a “cancellation” signal from a keypad controller (e.g. 1330 of FIG. 1), a touch panel controller (e.g. 1302 of FIG. 1) or a motion sensor (e.g. 1314 of FIG. 1), step S5200 determines to enter the “cancellation” mode and the process proceeds to step S5510. When receiving a “snooze activation” signal from a keypad controller (e.g. 1330 of FIG. 1), a touch panel controller (e.g. 1302 of FIG. 1) or a motion sensor (e.g. 1314 of FIG. 1), step S5200 determines to enter the “snooze activation” mode and the process proceeds to step S5410. The details of “cancellation” and “snooze activation” signal generation are provided in the following scenarios, and only briefly described herein.

Steps S5310 to S5330 are performed when entering the “no response” mode. In step S5310, the speaker is directed to stop buzzing or playing the alarm melody or tone. In step S5320, it is determined whether a “force wake-up” mechanism has been activated. If so, the process proceeds to step S5330, otherwise, the process ends. Activation of “force wake-up” mechanism may be preset via the described alarm clock MMI by a user. The object of the “force wake-up” mechanism is to periodically direct the speaker to buzz or play the alarm melody or tone until detecting that an alarm cancellation key has been pressed. In step S5330, the alarm time is reset by increasing a predetermined re-alarm duration such as three or five minutes or other. For example, when the re-alarm duration is set to twenty minutes, the alarm time is reset to twenty minutes later. An RTC (e.g. 1312 of FIG. 1) may be notified of a new alarm time setting via relevant RTC firmware drivers, enabling an alarm message to be received when reaching the new alarm time.

Step S5510 is performed when entering the “cancellation” mode. In step S5510, the speaker is directed to stop buzzing or playing the alarm melody or tone.

Steps S5410 to S5450 are performed when entering the “snooze activation” mode. In step S5410, the speaker is directed to stop buzzing or playing the predetermined melody or tone. In step S5415, the speaker is directed to play speech signals (i.e. human speech) to notify a user of information regarding that the speaker will buzz or play alarm melody after a predetermined delay duration such as ten or twenty minutes, or other. In step S5420, it is determined whether a “snooze activation” signal is detected during the predetermined detection period, such as two, five or ten seconds, or other. If so, the process proceeds to step S5430, otherwise, to step S5450. In step S5430, the delay duration is modified. The delay duration may be multiplied by the detected frequency of “snooze activation” signals. For example, when the delay duration is set to five minutes and the detected frequency of “snooze activation” signals is three, the delay duration is modified by 5×3=15 minutes. The delay duration may be modified with a cycle of delay duration according to the detected number of times of “snooze activation” signals. For example, while the cycle of delay duration contain delay durations of ten and twenty minutes, the delay duration is modified by ten, twenty, ten, twenty minutes and so on, when the detected number of times of “snooze activation” signals is one, two, three, four and so on. In step S5440, the speaker is directed to play speech signals to notify a user of information regarding that the speaker will buzz or play alarm melody after the modified delay duration. In step S5450, the alarm time is reset by increasing the modified delay duration. For example, when the final delay duration is set to twenty minutes, the alarm time is reset to twenty minutes later. An RTC (e.g. 1312 of FIG. 1) may be notified of the new alarm time setting via relevant RTC firmware drivers, enabling an alarm message to be received upon reaching the new alarm time. In some embodiments, steps S5415 and S5440 may be omitted. In some embodiments, steps S5415 and S5440 may be reduced to a single step between steps S5420 and S5450 or steps S5450 and S5100.

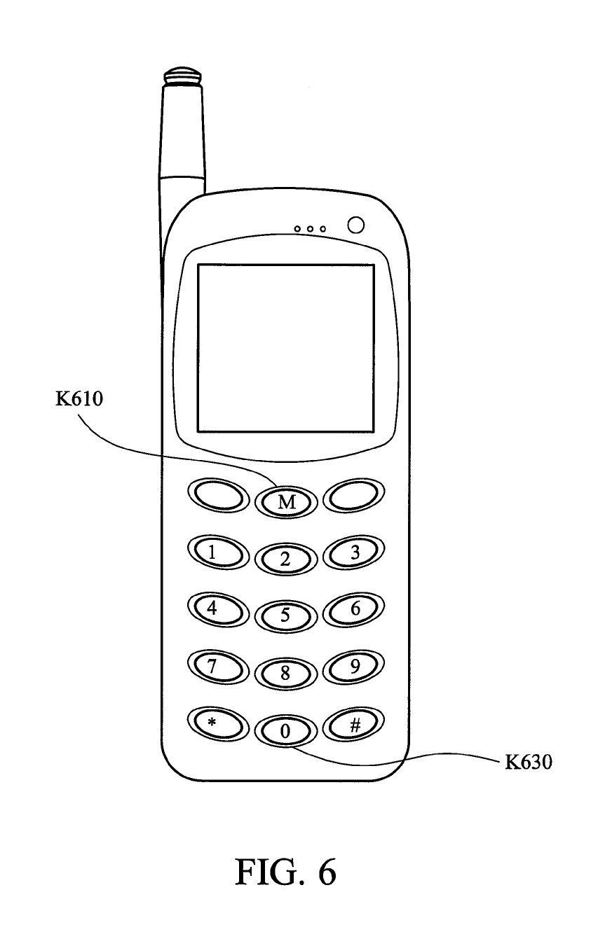

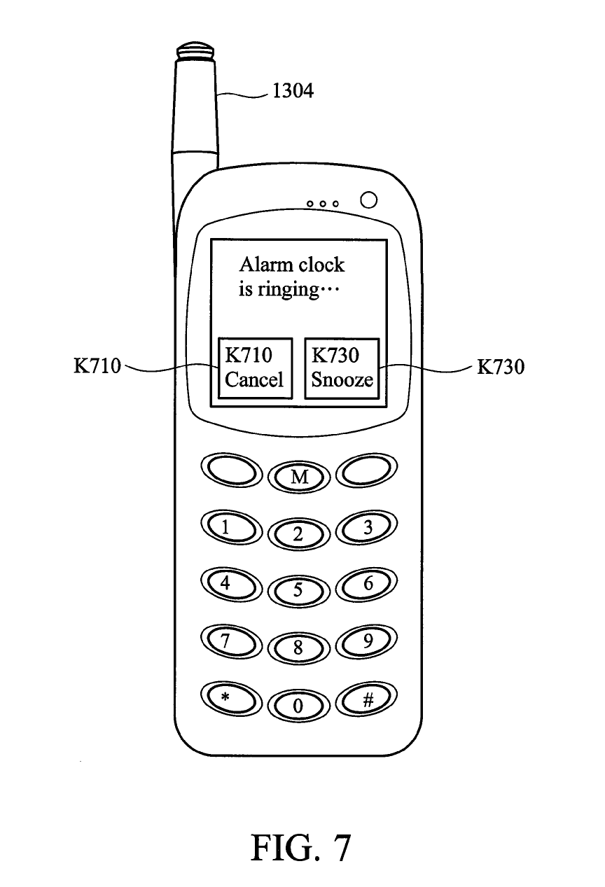

Three examples here illustrate details of the snooze control method of FIG. 5. In a first scenario, two hard keys on a keypad (e.g. 1331) can be configured as alarm cancellation and snooze activation keys via the alarm clock MMI. FIG. 6 is a diagram of the appearance of an embodiment of a mobile phone, where hard keys K610 and K630 on a keypad (e.g. 1331 of FIG. 1) are respectively configured as alarm cancellation and snooze activation keys. It is to be understood that at least one of the alarm cancellation key and the snooze activation key may be implemented in a soft key on a touch panel (e.g. 1323 of FIG. 1). FIG. 7 is a diagram of the appearance of an embodiment of a mobile phone, where soft keys K710 and K730 are respectively configured as alarm cancellation and snooze activation keys. Referring to step S5200 of FIG. 5, when receiving a key stroke signal corresponding to the hard key K610 (FIG. 6) from the keypad controller, or the soft key K710 (FIG. 7) from the touch panel controller, the “cancellation” mode is entered and step S5510 is carried out. When receiving a key stroke signal corresponding to the hard key K630 (FIG. 6) from the keypad controller, or the soft key K730 (FIG. 7) from the touch panel controller, the “snooze activation” mode is entered and step S5410 is carried out. Referring to step S5420 of FIG. 5, it is determined whether a key stroke signal corresponding to the hard key K630 from the keypad controller, or the soft key K730 from the touch panel controller is detected during the predetermined detection period, such as five or ten seconds, or other. Referring to step S5430 of FIG. 5, the delay duration may be multiplied by the detected key stroke times. For example, if the delay duration is set to five minutes and the hard key K630 is pressed three times or the soft key K730 is clicked three times, the delay duration is modified by 5×3=15 minutes. The delay duration may be modified with a cycle of delay duration according to the detected times of key strokes or clicks corresponding to the hard key K630 or the soft key K730. For example, if the cycle of delay duration contains delay durations of ten and twenty minutes, the delay duration is modified by ten, twenty, ten, twenty minutes and so on, when the hard key K630 is pressed or the soft key K730 is clicked once, twice, three, four times and so on.

In a second scenario, users may configure the hard key K630 (FIG. 6) or the soft key K730 (FIG. 7) as a snooze activation key via the described alarm clock MMI. The termination means may further be configured to terminate the alarm by shaking the mobile electronic device (e.g. 100 of FIG. 1). When a user shakes the mobile electronic device, a motion sensor therein (e.g. 1314 of FIG. 1) detects agitations, and the alarm is terminated. Referring to step S5200 of FIG. 5, upon detection of acceleration by the motion sensor exceeding a predetermined threshold such as a value between 500 and 1500 milli-gravity (mg), the “cancellation” mode is entered and step S5510 is carried out. To improve the detection accuracy of the “cancellation” signal, the determination approach performed in step S5200 may be adapted. The “cancellation” signal may be detected when the sensed acceleration by the motion sensor exceeds a predetermined threshold and, further, one hard key on the keypad is pressed. The “cancellation” signal may be detected when acceleration is detected by the motion sensor at least two times. Determination of “snooze activation” mode by step S5200 follows description of the first scenario. Steps S5420 and S5430 refer to relevant description of the first scenario.

In a third scenario, users may configure the hard key K610 (FIG. 6) or the soft key K710 (FIG. 7) as a cancellation key via the described alarm clock MMI. Snooze activation means may be further configured to activate snooze by shaking the mobile electronic device (e.g. 100 of FIG. 1). When a user shakes the mobile electronic device, a motion sensor therein (e.g. 1314 of FIG. 1) detects agitations, and the snooze function is activated. Referring to step S5200 of FIG. 5, when acceleration detected by the motion sensor exceeds a predetermined threshold such as a value between 500 and 1500 milli-gravity (mg), the “snooze activation” mode is entered and the step S5410 is carried out. To improve the detection accuracy of the “snooze activation” signal, several determination approaches may be adapted and performed in step S5200. The “snooze activation” signal may be detected when the sensed acceleration by the motion sensor exceeds a predetermined threshold and further, one hard key on the keypad is pressed. The “snooze activation” signal may be detected when the motion sensor senses acceleration exceeding a predetermined threshold at least two times. Determination of “cancellation” situation by step S5200 follows description of the first scenario.

Referring to step S5420 of FIG. 5, it is determined whether a snooze activation signal (i.e. an agitation) is detected by a motion sensor (e.g. 1314 of FIG. 1) during the predetermined detection period, such as one, five or ten seconds, or other. To improve the detection accuracy of one agitation, the determination approach performed in step S5420 may be adapted. One agitation may be detected when the sensed acceleration by the motion sensor exceeds a predetermined threshold and further, one hard key on the keypad is pressed. One agitation may be detected when the motion sensor senses accelerations exceeding a predetermined threshold at least two times. Referring to step S5430 of FIG. 5, the delay duration may be multiplied by the detected frequency of agitations. For example, when the delay duration is set to five minutes and the frequency of detected agitations is three, the delay duration is modified by 5×3=15 minutes. The delay duration may be modified by a cycle of delay duration according to the number of times of detected agitations. For example, if the cycle of delay duration contains delay durations of ten and twenty minutes, the delay duration is modified by ten, twenty, ten, twenty minutes and so on, when the number of times of detected agitations is once, twice, three, four times and so on.

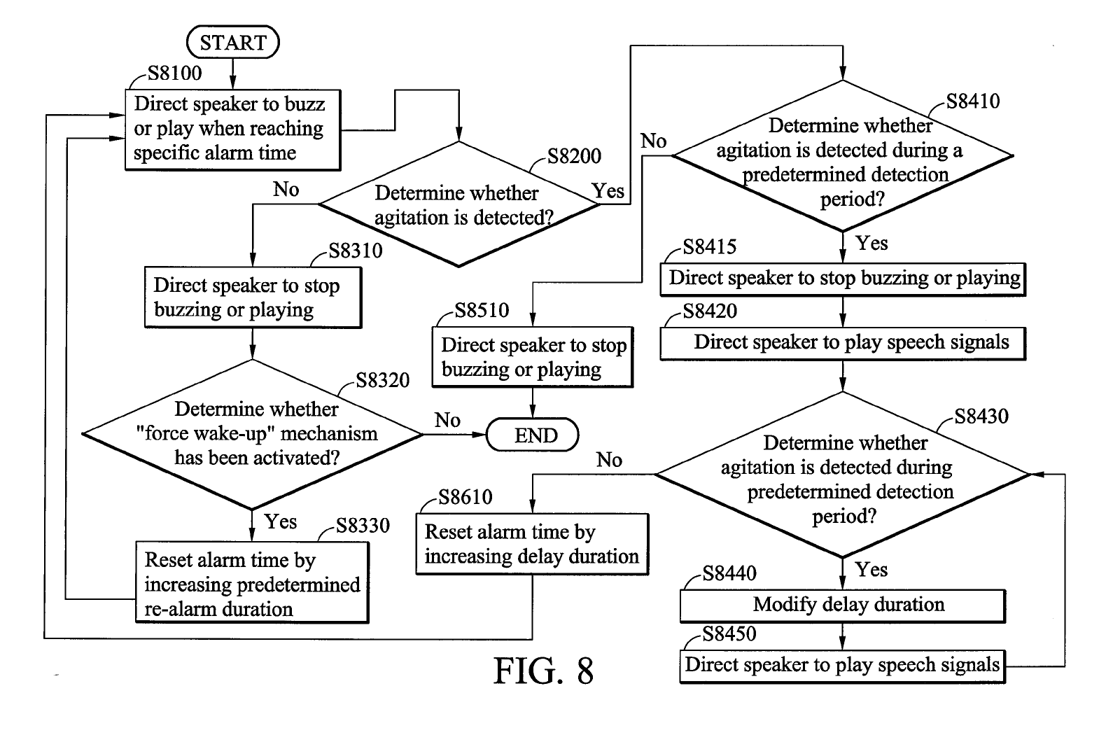

In a fourth scenario, the termination means may be configured to terminate that alarm by shaking the mobile electronic device (e.g. 100 of FIG. 1). When a user shakes the mobile electronic device, a motion sensor therein (e.g. 1314 of FIG. 1) detects agitations and the alarm is terminated. The snooze activation means may be further configured to activate the snooze by shaking the mobile electronic device. When a user shakes the mobile electronic device, the motion sensor therein detects agitations and the snooze function is activated. FIG. 8 is a flowchart illustrating an embodiment of a snooze control method, performed by a processor (e.g. 1305 or FIG. 1), as the fourth scenario. In step S8100, a speaker (e.g. 1303 of FIG. 1) is directed to buzz or play a predetermined alarm melody or tone when reaching a specific alarm time. The alarm time may be configured via the described alarm clock MMI by a user. The processor may detect that the specific alarm time is reached when an alarm message is received from the described ISR. In step S8200, it is determined whether an agitation is detected. If so, the process proceeds to step S8410, otherwise, to step S8310. Step S8200 may determine that an agitation is detected when the sensed acceleration by the motion sensor exceeds a predetermined threshold such as a value between 500 and 1500 milli-gravity (mg). Step S8200 may determine that an agitation is detected when the sensed acceleration by the motion sensor exceeds a predetermined threshold and further, one hard key on the keypad is pressed. Step S8200 may determine that an agitation is detected when acceleration exceeding a predetermined threshold is detected by the motion sensor at least two times. The details of steps S8310 to S8330 refers to relevant description of steps S5310 to S5330 of FIG. 5.

In step S8410, it is determined whether an agitation is detected during a predetermined detection period, such as one, five or ten seconds, or other. If so, the process proceeds to step S8415, otherwise, to step S8510. In steps S8415 and 8510, the speaker is directed to stop buzzing, or playing the predetermined melody or tone. In step S8420, the speaker is directed to play speech signals (i.e. human speech) to notify a user of information regarding that the speaker will buzz or play alarm melody after a predetermined delay duration such as ten or twenty minutes, or other. In step S8430 it is determined whether an agitation is detected during a predetermined detection period. If so, the process proceeds to step S8440, otherwise, to step S8610. Determination of an agitation may follow relevant description of step S8410. In step S8440, a delay duration is modified. The delay duration may be multiplied by the detected frequency of agitations. For example, when the delay duration is set to five minutes and the frequency of detected agitations is three, the delay duration is modified by 5×3=15 minutes. The delay duration may be modified by a cycle of delay duration according to the detected number of times of agitations. For example, if the cycle of delay duration contains delay durations of ten and twenty minutes, the delay duration is modified by ten, twenty, ten, twenty minutes and so on, when the number of times of detected agitations is once, twice, three, four times and so on. In step S8450, the speaker is directed to play speech signals (i.e. human speech) to notify a user of information regarding that the speaker will buzz or play alarm melody or tone after a predetermined delay duration such as ten or twenty minutes, or other. In step S8610, the alarm time is reset by increasing the modified delay duration. For example, when the final delay duration is set to be twenty minutes, the alarm time is reset to be twenty minutes later. An RTC (e.g. 1312 of FIG. 1) may be notified of a new alarm time setting via relevant RTC firmware drivers, enabling an alarm message to be received when reaching the new alarm time. In some embodiments, steps S8420 and S8450 may be omitted. In some embodiments, steps S8420 and S8450 may be reduced to a single step and placed between steps S8430 and S8610 or between steps S8610 and S8100.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in this technology can make various alterations and modifications without departing from the scope and spirit of the invention. The invention is not limited to merely test or simulation applications. Any applications relating to cross-platform message exchanging should be covered by the scope of the invention. Therefore, the scope of the invention shall be defined and protected by the following claims and their equivalents.

1. A method for controlling an alarm clock, employed in a mobile electronic device, comprising:
sounding when reaching an alarm time;
stopping sounding when detecting a first signal;
determining a number of times a second signal is detected during a predetermined detection period subsequent to the detected first signal, the predetermined detection period being about 10 seconds or less;
calculating a delay duration in response to the number of times the second signal is detected; and
resetting the alarm time by the calculated delay duration, wherein each second signal indicates that the mobile electronic device agitates.

2. The method as claimed in claim 1 wherein the sounding step further comprises buzzing or playing a predetermined melody or tone when reaching the alarm time.

3. The method as claimed in claim 1 further comprising playing speech signals to notify a user of information regarding that the mobile electronic device will sound after the calculated delay duration.

4. The method as claimed in claim 1 wherein the delay duration is calculated by multiplying a predetermined duration by the number of times of the detected second signals.

5. The method as claimed in claim 1 wherein the delay duration is calculated from one of a plurality of cyclic delay durations according to the number of times of the detected second signals.

6. (canceled)

7. The method as claimed in claim 1 wherein the mobile electronic device comprises at least one key on a keypad, or a touch panel, at least one of the first and second signals is a key stroke signal generated when the key is pressed, or the touch panel is clicked.

8. A system for controlling an alarm clock, disposed on a mobile electronic device, comprising:
a speaker; and
a processor coupled to the speaker, directing the speaker to sound when reaching an alarm time, directing the speaker to stop sounding when detecting a first signal, determining a number of times a second signal is detected during a predetermined detection period subsequent to the detected first signal, the predetermined detection period being about 10 seconds or less, calculating a delay duration in response to the number of times the second signal is detected, and resetting the alarm time by the calculated delay duration; and
a motion sensor,
wherein at least one of the first and second signals is detected when the processor determines that acceleration exceeding a predetermined threshold is detected by the motion sensor at least two times.

9. The system as claimed in claim 8 wherein the speaker is directed to buzz or play a predetermined melody or tone when reaching the alarm time.

10. The system as claimed in claim 8 further comprising a real-time clock (RTC), wherein the alarm time is reached when receiving an alarm interrupt from the RTC.

11. (canceled)

12. The system as claimed in claim 8 further comprising at least one of a keypad and touch panel controller, wherein at least one of the first and second signals is detected when the processor receives a key stroke signal from the keypad or touch panel controller.

13. (canceled)

14. The system as claimed in claim 8 wherein the processor directs the speaker to play speech signals in order to notify a user of information regarding that the mobile electronic device will sound after the calculated delay duration.

15. The system as claimed in claim 8 wherein the delay duration is calculated by multiplying a predetermined duration by the number of times of the detected second signals.

16. The system as claimed in claim 8 wherein the delay duration is calculated from one of a plurality of cyclic delay durations according to the number of times the second signal is detected.
